(19) United States
(12) Patent Application Publication
(10) Pub. No.: US 2015/0102043 A1
(43) Pub. Date: Apr. 16, 2015

(54) FIRE RESISTANT PRESSURE VESSEL

(71) Applicants: Francesco Nettis, London (GB); Brian Spencer, Sacramento, CA (US); Zachary Spencer, Sacramento, CA (US)

(72) Inventors: Francesco Nettis, London (GB); Brian Spencer, Sacramento, CA (US); Zachary Spencer, Sacramento, CA (US)

(21) Appl. No.: 14/362,550

(22) PCT Filed: Dec. 5, 2011
(86) PCT No.: PCT/EP2011/071812

§ 371 Date: Dec. 19, 2014

(51) Int. Cl. F17C 1/04; F17C 13/08

(52) U.S. Cl. CPC F17C 1/04; F17C 13/08; F17C 2203/0602
USPC 220/586

(57) ABSTRACT

The present invention relates to a fire resistant pressure vessel in which the inclusion of fire resistance does add appreciably to the overall weight of the vessel over a similar vessel that is not fire resistant.

### FIELD

This invention relates to a pressure vessel comprising a fire resistant outer layer wherein that layer does not increase the weight of the pressure vessel over a similar vessel that is the same in all respects except that it is not fire resistant.

### BACKGROUND

The detrimental effects of the burning of fossil fuels on the environment are becoming more and more of a concern and have spurred great interest in alternative energy sources. While progress is being made with solar, wind, nuclear, geothermal, and other energy sources, it is quite clear that the widespread availability of economical alternate energy sources, in particular for high energy use applications, remains an elusive target. In the meantime, fossil fuels are forecast to dominate the energy market for the foreseeable future. Among the fossil fuels, natural gas is the cleanest burning and therefore the clear choice for energy production. There is, therefore, a movement afoot to supplement or supplant, as much as possible, other fossil fuels such as coal and petroleum with natural gas as the world becomes more conscious of the environmental repercussions of burning fossil fuels. Unfortunately, much of world's natural gas deposits exist in remote, difficult to access regions of the planet. Terrain and geopolitical factors render it extremely difficult to reliably and economically extract the natural gas from these regions. The use of pipelines and overland transport has been evaluated, in some instances attempted, and found to be uneconomical. Interestingly, a large portion of the earth's remote natural gas reserves is located in relatively close proximity to the oceans and other bodies of water having ready access to the oceans. Thus, marine transport of natural gas from the remote locations would appear to be an obvious solution. The problem with marine transport of natural gas lies largely in the economics. Ocean-going vessels can carry just so much laden weight and the cost of shipping by sea reflects this fact, the cost being calculated on the total weight being shipped, that is, the weight of the product plus the weight of the container vessel in which the product is being shipped. If the net weight of the product is low compared to the tare weight of the shipping container, the cost of shipping per unit mass of product becomes prohibitive. This is particularly true of the transport of compressed fluids, which conventionally are transported in steel cylinders that are extremely heavy compared to weight of contained fluid. This problem has been ameliorated somewhat by the advent of Type III and Type IV pressure vessels. Type III pressure vessels are comprised of a relatively thin metal liner that is wound with a filamentous composite wrap, which results in a vessel with the strength of a steel vessel at a substantial saving in overall vessel weight. Type IV pressure vessels comprise a polymeric liner that is likewise wrapped with a composite filamentous material. Type IV pressure vessels are the lightest of all the presently approved pressure vessels. The use of Type III and Type IV vessels coupled with the trend to make these vessels very large—cylindrical vessels 18 meters in length and 2.5-3.0 meters in diameter are currently being fabricated and vessel 30 or more meters in length and 6 or more meters in diameter are contemplated—has resulted in a major step forward in optimizing the economics of ocean transport of compressed fluids.

A problem that must be confronted when designing pressure vessels for the transport of highly flammable fluids is safety, in particular with regard to pressure vessels comprising a polymeric outer shell, which usually is a composite. Fire safety is most often achieved by applying an additional fire resistant coating on top of whatever polymeric material is already being used as the matrix polymer for the composite. A variety of fire resistant polymers can be used as the fire resistant coating, for example phenolic resins. Such resins, however, add to the overall weight of the pressure vessel thereby reversing some of the gains made with pressure vessels that comprise a weight-reducing composite.

What is needed is a pressure vessel comprising a composite over-wrap that includes a fire resistant substance yet that is as light as would be the same vessel without the fire resistant substance. The present invention seeks to provide such a pressure vessel.

### SUMMARY

Thus, in one aspect, the present invention relates to a fire resistant pressure vessel, comprising a composite outer layer comprising a fire resistant polymer. With this arrangement the weight of the fire resistant pressure vessel may be less than or equal to the weight of a similar pressure vessel that is not fire resistant.

In an aspect of this invention, the composite outer layer is formed from a prepolymer formulation comprising monomers that give rise to a fire resistant polymer matrix.

In an aspect of this invention, the composite outer layer is formed from a prepolymer formulation comprising a blend of one or more monomers that give rise to a fire-resistant polymer and one or more monomers that give rise to a non-fire-resistant polymer such that, when polymerized, the blend gives rise to a fire resistant polymer matrix.

In an aspect of this invention, the monomers that give rise to a non-fire-resistant polymer matrix comprise dicyclopentadiene.

In an aspect of this invention, the dicyclopentadiene is at least 92% pure. In an aspect of this invention, the blend comprises non-fire resistant monomers in about 1 wt % to about 90 wt % of the total monomer content of the prepolymer formulation.

In an aspect of this invention, the fire resistant composite outer layer comprises an inner sub-layer and an outer sub-layer.

The inner sub-layer may comprise a filamentous material impregnated with and embedded in a matrix polymer

The outer sub-layer may comprise a filamentous material impregnated with and embedded in a fire resistant polymer or a blend of the fire resistant polymer with about 1 wt % to about 90 wt % of the matrix polymer.

The weight of the fire resistant pressure vessel may be equal to or less than the weight of a similar vessel without the fire resistant polymer incorporated into the outer sub-layer.

In an aspect of this invention, the outer sub-layer is greater than or equal to about 0.125″ thick.

In an aspect of this invention, the matrix polymer is selected from the group consisting of a thermoplastic polymer and a thermoset polymer.

In an aspect of this invention, the thermoset polymer is selected from the group consisting of an epoxy resin, a vinyl ester resin, a bismaleimide resin, a cyanate ester resin and a dicyclopentadiene resin.

In an aspect of this invention, the fire resistant polymer is selected from the group consisting of a phenolic resin, an amine-cure epoxy resin, and an anhydride-cured epoxy resins.

In an aspect of this invention, the outer sub-layer further comprises a flame retardant.

In an aspect of this invention, the flame retardant is aluminum trihydrate.

In an aspect of this invention, the pressure vessel further comprises a pressure vessel liner. The liner may be contiguous with an inner sub-layer surface of the outer layer.

In an aspect of this invention, the liner is selected from the group consisting of a thermoplastic polymer, a thermoset polymer, a ceramic, a metal and combinations thereof.

In an aspect of this invention, the thermoset polymer is formed from a prepolymer formulation comprising dicyclopentadiene.

In an aspect of this invention, the dicyclopentadiene is at least 92% pure.

In an aspect of this invention, the pressure vessel is selected from the group comprising a central cylindrical section with one or two domed end sections, a sphere, an oblate spheroid or a torus.

In an aspect of this invention, the vessel is used for the transportation of compressed natural gas.

In an aspect of this invention, the compressed natural gas comprises raw natural gas.

The outer layer may be part of the structural design of the vessel, i.e. not a post production coating. For example, it may be incorporated into the production process as part of the final wrapping layer or layers.

The vessel may be filled with compressed natural gas. The compressed natural gas may be at a pressure of about 250 bar.

An aspect of this invention is a ship comprising the fire resistant pressure vessel defined above.

### BRIEF DESCRIPTION OF THE FIGURES

The figures shown are provided for illustrative purposes only and are not intended nor should they be construed as limiting this invention in any manner whatsoever.

FIG. 1 shows various configurations of pressure vessels that can be formed using a fire resistant composite of this invention.

FIG. 1A shows a spherical pressure vessel.

FIG. 1B shows an oblate spheroidal pressure vessel.

FIG. 1C shows a toroidal pressure vessel.

FIG. 1D shows a pressure vessel comprising a cylindrical center section with one domed end section.

FIG. 1E shows a pressure vessel comprising a cylindrical center section with two domed end sections.

### DETAILED DESCRIPTION

### Discussion

It is understood that, with regard to this description and the appended claims, any reference to any aspect of this invention made in the singular includes the plural and vice versa unless it is expressly stated or unambiguously clear from the context that such is not intended.

As used herein, any term of approximation such as, without limitation, near, about, approximately, substantially, essentially and the like, means that the word or phrase modified by the term of approximation need not be exactly that which is written but may vary from that written description to some extent. The extent to which the description may vary will depend on how great a change can be instituted and have one of ordinary skill in the art recognize the modified version as still having the properties, characteristics and capabilities of the word or phrase unmodified by the term of approximation. In general, but with the preceding discussion in mind, a numerical value herein that is modified by a word of approximation may vary from the stated value by ±10%, unless expressly stated otherwise.

As used herein, “contiguous” refers to two surfaces that are adjacent and that are in direct contact or that would be in direct contact were it not for an intervening layer of another material.

As used herein, the use of “preferred,” “preferably,” or “more preferred,” and the like refers to preferences as they existed at the time of filing of this patent application.

As used herein, a “fluid” refers to a gas, a liquid or a mixture of gas and liquid. For example, without limitation, natural gas as it is extracted from the ground and transported to a processing center is often a mixture of the gas with liquid contaminants. Such mixture would constitute a fluid for the purposes of this invention.

As used herein, a “wrap” or “over-wrap” refers to the winding of a filamentous material around a pressure vessel liner. The filamentous material may be wound around the pressure vessel in a dry state and then impregnated with a polymeric matrix or it may be impregnated with a polymeric matrix material prior to being wound onto the pressure vessel liner.

As used herein, a “pressure vessel” refers to any closed container designed to hold fluids at a pressure substantially different from ambient pressure. In particular at present, it refers to such containers used to hold and transport compressed natural gas, CNG. Pressure vessels may take a variety of shapes but most often seen in actual use are spherical, oblate spheroidal, toroidal and cylindrical center section vessels with domed end sections at either or both ends.

Pressure vessels for the transport of compressed fluids presently constitute four regulatory agency approved classes, all of which are cylindrical with one or two domed ends:

Type I. Comprises of metal, usually aluminum or steel. This type of vessel is inexpensive but is very heavy in relation to the other classes of vessels. Although Type I pressure vessels currently comprise a large portion of the containers used to ship compressed fluids by sea, their use in marine transport incurs very tight economic constraints.

Type II. Comprises a thinner metal cylindrical center section than a Type I vessel but with standard thickness metal end domes in which only the cylindrical portion is reinforced with a composite wrap. The composite wrap generally constitutes glass or carbon filament impregnated with a polymer matrix. The composite is usually “hoop wrapped” around the middle of the vessel. The domes at one or both ends of the vessel are not composite wrapped. In Class II pressure vessels, the metal liner withstands about 50% of the stress and the composite withstands about 50% of the stress resulting from the internal pressure of the contained compressed fluid. Class II vessels are lighter than Class I vessels but are more expensive.

Type III. Comprises a thin metal liner as the entire sub-structure wherein the liner is reinforced with a filamentous composite wrap around the entire vessel. The stress in Type III vessels is shifted virtually entirely to the filamentous material of the composite wrap; the liner need only withstand a small portion of the stress. Type III vessels are much lighter than type I or II vessels but are substantially more expensive.

Type IV. Comprises a polymeric essentially gas-tight liner fully wrapped with a filamentous composite. The composite wrap provides the entire strength of the vessel. Type IV vessels are the lightest of the four approved classes of pressure vessels but are also the most expensive.

As mentioned above, currently approved pressure vessels consist predominantly of pressure vessels with cylindrical center sections and one or two domed end sections. For the purpose of this disclosure, such vessel will be referred to simply as cylindrical pressure vessels.

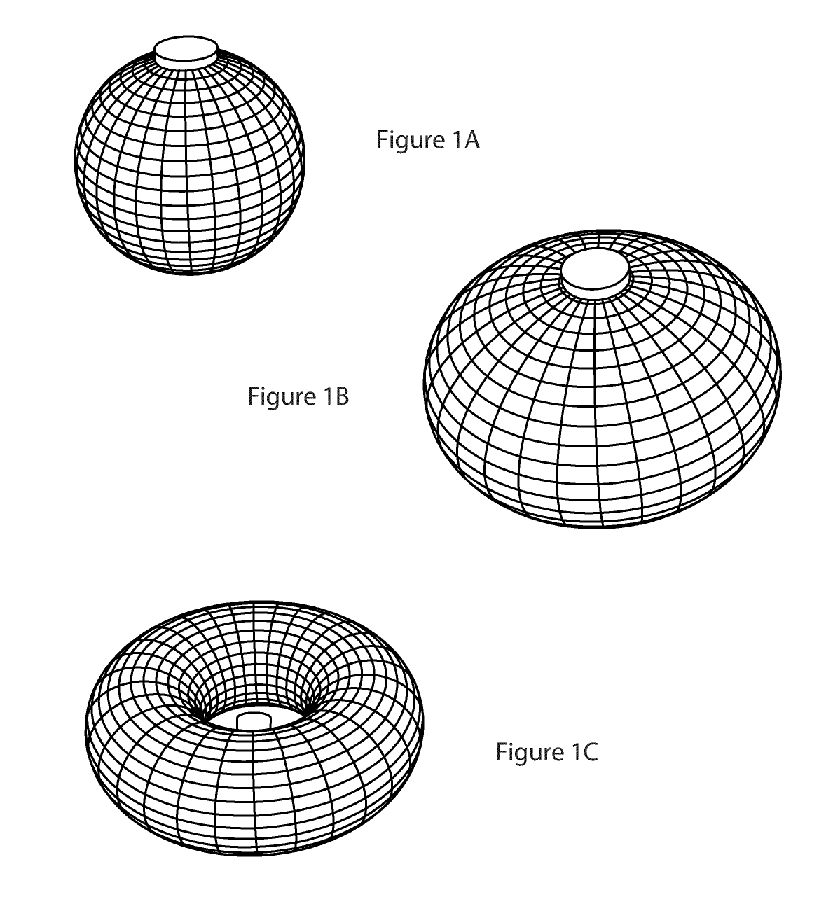

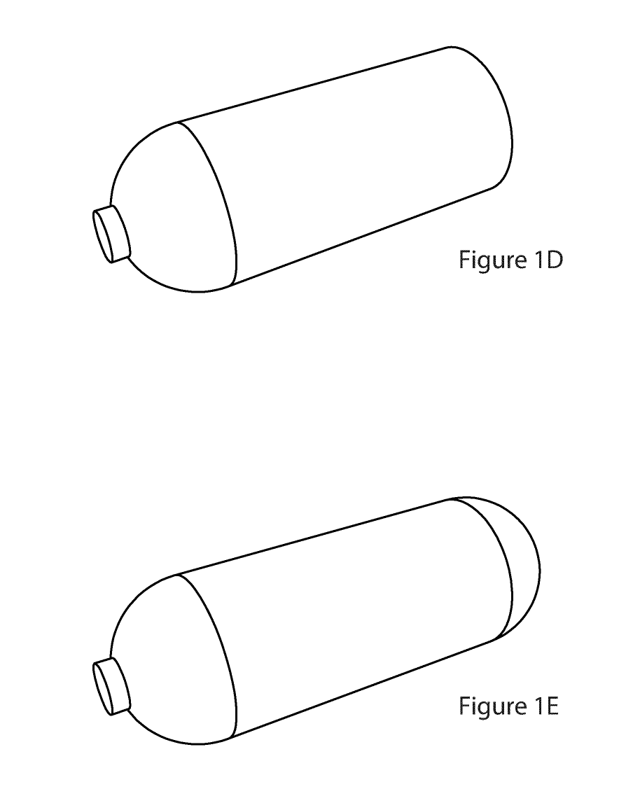

FIG. 1 illustrates various pressure vessel shapes. FIG. 1A shows a spherical vessel, FIG. 1B shows an oblate spheroid vessel, FIG. 1C a toroidal vessel, FIG. 1D, a cylindrical vessel with one domed end section and FIG. 1E, a cylindrical vessel with two domed end sections. Vessel size may also vary tremendously and the construct and methods of this invention may be applied to a vessel of any size. For example, without limitation, a pressure vessel of this invention may be a small laboratory bench top vessel or a vessel for use in alternative fuel vehicles as well as vessels of the size contemplated herein for the marine transport of compressed fluids. In a presently preferred embodiment, very large pressure vessels are contemplated, for example, without limitation, the cylindrical vessels previously mentioned, i.e., vessels that are 18 or more meters in length and 2.5 or more meters in diameter as well as vessels anticipated to be in excess of 30 meters in length and 6 meters in diameter. All will be amenable to application of the fire resistant layer of this invention.

A fire resistant pressure vessel of this invention may consist of a liner comprising any material currently used for pressure vessel liners or any material that may be developed in the future for such use. Current established pressure vessel liner materials include, without limitation, polymers such as high density polyethylene, polypropylene and polyethylene terephthalate, ceramics such as alumina, silicon carbide, silicon nitride and zirconia and metals such as stainless steel, titanium, nickel alloys, aluminum, copper, zinc, tin. Preferred at present are thin metal liners and polymeric liners that are over-wrapped with a polymeric composite to ultimately give rise to Type III, Type IV and Type V pressure vessels. Both thermoplastic and thermoset polymers have been used to form pressure vessel liners and any of these may be used in the present invention when a composite fire resistant outer layer of this invention is also used. Of the polymeric materials suitable as a pressure vessel liner, presently preferred is a liner made by polymerization of a prepolymer formulation that comprises at least 92% pure dicyclopentadiene (DCPD).

The fire resistant composite outer layer is applied over the liner and may comprise a filamentous material impregnated with and embedded in a fire resistant polymer matrix. The fire resistant polymer matrix may be formed from a fire resistant prepolymer formulation that comprises the monomer or monomers that, when cured, provide the fire resistant polymer. In the alternative, the fire resistant polymer matrix may be formed from a fire resistant prepolymer formulation that is a blend of the monomers that give rise to a fire resistant polymer and monomers that give rise to a conventional composite matrix polymer. Preferably at present, the fire resistant prepolymer formulation comprises dicyclopentadiene that is at least 92% pure and monomers that give rise to a fire resistant polymer.

In yet another alternative, the fire resistant composite outer layer of a pressure vessel of this invention may comprise two sub-layers, an inner sub-layer, which is contiguous to the liner and an outer sub-layer that is contiguous with the inner sub-layer and is in contact with the environment, the outer sub-layer providing the fire resistant surface of the pressure vessel.

In the above embodiment, the inner sub-layer comprises a filamentous material that is impregnated with and embedded in a matrix polymer. With regard to the filamentous material, any known material with the requisite strength properties or any such material that may become known in the future to have the requisite characteristics for use in the manufacture of pressure vessels may be used as the filamentous material component of the polymeric composite. The filamentous material can be comprised of, for example without limitation, single strands of material, multiple individual threads, which may remain as a bundle of separate threads or may be woven together into multi-thread strands, or it may be a filamentous tape, i.e. a construct having a cross-section with a width that is greater than its thickness. Such materials presently include, without limitation, metal filaments, ceramic filaments, natural filaments (such as without limitation flax, hemp or cotton), glass filaments, e.g., fiberglass, carbon filaments, aramid filaments, sometimes referred to by the trade name Kevlar® and ultra-high molecular weight polyethylene filaments, such as those sold under the tradenames Spectra® (Honeywell Corporation) and Dyneeva® (Royal DSM N.V.). Combinations of these filamentous materials may also be used.

As for the matrix material of the composite, any polymer known or found to have properties consistent with use in pressure vessels can be used, it being understood that generally speaking the polymeric matrix of a composite is not required to withstand any of the pressure generated in the vessel by the contained fluid; the filamentous material absorbs it all.

While thermoplastic polymers, thermoplastic elastomers, thermoset resins and combinations thereof can be used as matrix materials, presently preferred are thermoset polymers, which can exhibit significantly better mechanical properties, chemical resistance, thermal stability and overall durability than the other types of polymers. An advantage of many thermoset plastics or resins is that they tend to have low viscosities at temperatures around ambient and therefore can be introduced into or combined with fibers and filaments and further manipulated quite easily at room temperature. As used herein, “ambient temperature” simply refers to the temperature in the environs where application and curing of the prepolymer is to occur, wherein the environs is not heated specifically to achieve a suitable application and curing temperature. Generally, ambient temperature is from about 55° F. to about 100° F., although the presently preferred dicyclopentadiene-containing prepolymer formulation of this invention may be used at ambient temperatures both above and, particularly, well below this range. This avoids the need for special temperature-controlled environments, an exceedingly beneficial objective particularly when fabricating very large pressure vessels such as those described earlier. Another advantage of thermoset polymers it that they can usually be cured isothermally, that is, at the same temperature at which they are combined with the fibers/filaments, which can, again, be ambient temperatures.

Suitable thermoset resins include, without limitation, epoxy resins, polyester resins, vinyl ester resins, polyimide resins and dicyclopentadiene resins. Presently preferred are dicyclopentadiene resins in particular dicyclopentadiene resins made from a prepolymer formulation comprising dicyclopentadiene that is at least 92% pure.

Once a liner material has been selected and a liner fabricated, the composite outer layer this invention may be placed over the liner. First an inner sub-layer is applied. This can be accomplished in at least two ways. The selected filamentous material may be dry-wound around the liner and then may be impregnated with a selected composite matrix prepolymer such as, without limitation, the dicyclopentadiene prepolymer formulation mentioned above. In the alternative, the filamentous material may be first impregnated with the matrix prepolymer formulation by drawing the material through a reservoir of the prepolymer formulation and then wet-winding the impregnated filamentous material around the liner. In either case, once the filamentous material/prepolymer formulation has been applied to the liner, the prepolymer formulation is cured, that is, polymerized to form the inner sub-layer.

As used herein, a “prepolymer formulation” refers to a blend of a monomer or monomers that will eventually become the polymeric matrix of the composite, a curing agent and any other additives that are deemed desirable in the inner sub-layer. A DCPD prepolymer formulation refers to a blend of at least 92% pure DCPD with the other substances previously mentioned.

Winding patterns for applying the filamentous material to the liner are well known in the art and need not be discussed at length herein. In brief, if the pressure vessel is spherical or an oblate spheroid, the entire vessel is wound with the filamentous material in an isotensoidal pattern. If the pressure vessel is cylindrical, the vessel may be wound isotensoidally only or it may be hoop-wound in its cylindrical section and isotensoidally wound in both its cylindrical and its domed end-cap sections. A cylindrical Type II pressure vessel, which may benefit from this invention, is generally only hoop-wound around its cylindrical portion, the domed ends generally not having a composite over-wrap.

By “isotensoidal” is meant that each filament of the wrap experiences a constant pressure at all points in its path. As mentioned previously, the term “wrap” or “over-wrap” is used herein to describe the end result of winding of a filamentous material around a pressure vessel shell. Isotensoidal winding—or an isotensoidal wrap—is currently considered to be the optimal design for a cylindrical composite pressure vessel because, in this configuration, virtually the entire stress imposed on the vessel by a contained fluid under pressure is absorbed by the filaments of the composite with very little of the stress being assumed by the polymeric matrix.

“Hoop-wound” refers to the winding of a filamentous material around a vessel liner in a circumferential pattern.

Once the inner sub-layer has been cured, an outer sub-layer is applied over the cured inner sub-layer. An outer sub-layer of this invention may be of any desired thickness, the primary determinant being the thickness of the filamentous material in the wrap. It is presently preferred that the outer sub-layer be at least 0.125″ thick.

The prepolymer formulation used to create the outer sub-layer may comprise a monomer or monomers that, when polymerized, provide a fire resistance outer sub-layer. In the alternative, these monomers may be blended with the monomers that gave rise to the inner sub-layer, thereby forming, on curing, a matrix polymer that, by virtue of the first resistant polymer content, is fire resistant.

Polymers that may be used as the fire resistant outer sub-layer or outer sub-layer component include, without limitation, phenolic resins, amine-cured epoxy resins and anhydride-cured epoxy resins. Presently preferred are phenolic resins.

The outer sub-layer may be applied in the same manner as the inner sub-layer. That is, additional filamentous material may be dry-wound around the inner sub-layer and then may be impregnated with the fire resistant prepolymer formulation. In the alternative, the filamentous material may be drawn through a reservoir of the fire resistant prepolymer formulation and then can be wet-wound on the inner sub-layer.

If desired, a flame retardant substance may also be included in the outer sub-layer prepolymer or prepolymer blend to provide further fire resistance. Any fire resistant substance currently known or that becomes known in the future may be added to the prepolymer or blend. Presently preferred is aluminum trihydrate, sometimes referred to as aluminum hydroxide or hydrate of alumina. It is presently preferred that about 15 wt % to about 20 wt % based on the total weight of monomers present be included in the fire resistant prepolymer formulation.

As mentioned previously, while virtually any matrix polymers may be used as the inner sub-layer and in the outer sub-layer blend with a fire resistant polymer, presently preferred are dicyclopentadiene polymers. As used herein, dicyclopentadiene polymers refer to the homopolymer, poly(dicyclopentadiene), and to copolymers of dicyclopentadiene with other reactive ethylene monomers, wherein “reactive ethylene monomer” simply refers to a molecule comprising at least one —CH═CH— group. While any purity of dicyclopentadiene that properly cures under the selected conditions may be used in the prepolymer formulation, it is presently preferred that the cyclopentadiene monomer be at least about 92% pure.

When a blend of fire resistant polymer and matrix polymer is selected for the outer sub-layer, it is presently preferred that the blend comprise from about 1 wt % to about 90 wt % of the matrix polymer.

A key aspect of this invention is that when the substances that impart fire resistance on the outer sub-layer of the outer layer are included in the fabrication of the pressure vessel, doing so does not appreciably increase the overall weight of the pressure vessel over that of a similar vessel that is not fire resistant. A “similar vessel” comprises a vessel in which the amount of a non-fire resistant composite over-wrap has been calculated so as to provide a minimum workable over-wrap for a particular pressure vessel. This over-wrap then has a particular weight which is considered the base weight of the pressure vessel. That is, with any less over-wrap, the vessel would not meet the requirements of a pressure vessel for the intended use. The substances that confer fire resistance on the pressure vessel then replace, rather than add to the weight of the fire resistant prepolymer formulation. The same quantity of the fire resistant prepolymer formulation as that calculated for a non-fire resistant formulation is used to coat the pressure vessel, resulting in a fire-resistant pressure vessel that weighs no more than its non-fire resistant counterpart.

While pressure vessel of this application can be used to transport virtually any fluid so long at the matrix polymer of the vessel liner is selected to be inert to and impenetrable to the fluid, a presently preferred use of a pressure vessel herein is for the containment and transport of natural gas, often referred to as “compressed natural gas” or simply “CNG.”

CNG may be contained and transported in the vessels of this invention both as a purified gas and as “raw gas.” Raw gas refers to natural gas as it comes, unprocessed, directly from the well. It contains, of course, the natural gas (methane) itself but also may contain liquids such as condensate, natural gasoline and liquefied petroleum gas. Water may also be present as may other gases, either in the gaseous state or dissolved in the water, such as nitrogen, carbon dioxide, hydrogen sulfide and helium. Some of these may be reactive in their own right or may be reactive when dissolved in water, such as carbon dioxide which produces an acid when dissolved in water.

The presently preferred liner polymer, dicyclopentadiene, has excellent properties with regard to chemical resistance to the above materials, and other materials that might constitute raw gas.

In other words, the pressure vessels described herein can carry a variety of gases, such as raw gas straight from a bore well, including raw natural gas, e.g. when compressed—raw CNG or RCNG, or H₂, or CO₂ or processed natural gas (methane), or raw or part processed natural gas, e.g. with CO₂ allowances of up to 14% molar, H₂S allowances of up to 1,000 ppm, or H₂ and CO₂ gas impurities, or other impurities or corrosive species. The preferred use, however, is CNG transportation, be that raw CNG, part processed CNG or clean CNG—processed to a standard deliverable to the end user, e.g. commercial, industrial or residential.

CNG can include various potential component parts in a variable mixture of ratios, some in their gas phase and others in a liquid phase, or a mix of both. Those component parts will typically comprise one or more of the following compounds: C₂H₆, C₃H₈, C₄H₁₀, C₅H₁₂, C₆H₁₄, C₇H₁₈, C₈H₁₈, C₉+ hydrocarbons, CO₂ and H₂S, plus potentially toluene, diesel and octane in a liquid state, and other impurities/species.

These and other features of the present invention may be used independently or in combination, within the scope of the claims and/or the present disclosure.

The present invention has therefore been described above purely by way of example. Modifications in detail may be made to the invention within the scope of the claims appended hereto.

1. A fire resistant pressure vessel, comprising a composite outer layer comprising a fire resistant polymer wherein the weight of the fire resistant pressure vessel is less than or equal to the weight of a similar pressure vessel that is not fire resistant.

2. The fire-resistant pressure vessel of claim 1, wherein the composite outer layer is formed from a prepolymer formulation comprising monomers that give rise to a fire resistant polymer matrix.

3. The fire resistant pressure vessel of claim 1, wherein the composite outer layer is formed from a prepolymer formulation comprising a blend of one or more monomers that give rise to a fire-resistant polymer and one or more monomers that give rise to a non-fire-resistant polymer such that, when polymerized, the blend gives rise to a fire resistant polymer matrix.

4. The fire resistant pressure vessel of claim 3, wherein the monomers that give rise to a non-fire-resistant polymer matrix comprise dicyclopentadiene.

5. (canceled)

6. The fire resistant pressure vessel of claim 3, wherein the blend comprises non-fire resistant monomers in about 1 wt % to about 90 wt % of the total monomer content of the prepolymer formulation.

7. The fire-resistant pressure vessel of claim 1, wherein the fire resistant composite outer layer comprises an inner sub-layer and an outer sub-layer, wherein:
the inner sub-layer comprises a filamentous material impregnated with and embedded in a matrix polymer; and
the outer sub-layer comprising the filamentous material impregnated with and embedded in a fire resistant polymer or a blend of the fire resistant polymer with about 1 wt % to about 90 wt % of the matrix polymer, wherein:
the weight of the fire resistant pressure vessel is equal to or less than the weight of a similar vessel without the fire resistant polymer incorporated into the outer sub-layer.

8. The fire resistant pressure vessel of claim 7, wherein the outer sub-layer is greater than or equal to about 0.125″ thick.

9. The fire resistant pressure vessel of claim 7, wherein the matrix polymer is selected from the group consisting of a thermoplastic polymer and a thermoset polymer.

10. The fire resistant pressure vessel of claim 9, wherein the thermoset polymer is selected from the group consisting of an epoxy resin, a vinyl ester resin, a bismaleimide resin, a cyanate ester resin and a dicyclopentadiene resin.

11. The fire resistant pressure vessel of claim 7, wherein the matrix polymer is selected from the group consisting of a phenolic resin, an amine-cure epoxy resin, and an anhydride-cured epoxy resins.

12. The fire resistant pressure vessel of claim 7, further comprising a flame retardant in the outer sub-layer.

13. The fire resistant pressure vessel of claim 12, wherein the flame retardant is aluminum trihydrate.

14. The fire resistant pressure vessel of claim 7, comprising a pressure vessel liner that is contiguous with an inner sub-layer surface of the outer layer.

15. The fire resistant pressure vessel of claim 14, wherein the liner is selected from the group consisting of a thermoplastic polymer, a thermoset polymer, a ceramic, a metal and combinations thereof.

16. The fire resistant pressure vessel of claim 15, wherein the liner is made of a thermoset polymer formed from a prepolymer formulation comprising dicyclopentadiene.

17.-18. (canceled)

19. The fire resistant pressure vessel of claim 1, wherein the vessel is adapted to be used for the transportation of a compressed gas selected from the group consisting of compressed natural gas and compressed raw natural gas.

20. (canceled)

21. The fire resistant pressure vessel of claim 1, wherein outer layer is part of the structural design of the vessel.

22. The fire resistant pressure vessel of claim 1, wherein the outer layer is not a post production coating.

23. The fire resistant pressure vessel of claim 1, wherein the outer layer is incorporated into the production process as part of the final wrapping layer or layers.

24. (canceled)

25. A ship comprising the fire resistant pressure vessel of claim 1.
